(19) United States
(12) Patent Application Publication
(10) Pub. No.: US 2014/0298821 A1
(43) Pub. Date: Oct. 9, 2014

(54) GAS TURBINE ENGINE PROVIDED WITH HEAT EXCHANGER, AND METHOD FOR STARTING SAME

(71) Applicant: KAWASAKI JUKOGYO KABUSHIKI KAISHA, Kobe-shi (JP)

(72) Inventors: Yoshihiro YAMASAKI, Kobe-shi (JP); Soh KUROSAKA, Kobe-shi (JP); Yasushi DOURA, Kobe-shi (JP)

(73) Assignee: KAWASAKI JUKOGYO KABUSHIKI KAISHA, Kobe-shi (JP)

(21) Appl. No.: 14/307,970

(22) Filed: Jun. 18, 2014

Related U.S. Application Data
(63) Continuation of application No. PCT/JP2012/081814, filed on Dec. 7, 2012.

(30) Foreign Application Priority Data
Dec. 22, 2011 (JP) 2011-280947

(51) Int. Cl. F02C 7/26

(52) U.S. Cl. CPC F02C 7/26
USPC 60/778; 60/786

(57) ABSTRACT

A method of starting a gas turbine engine includes a primary warming step of warming a heat exchanger (6) by means of a compressed gas (G1) while with the use of an inverter motor (IM) the rotation speed of the engine is maintained at a partial rotation speed, a secondary warming step of warming the heat exchanger (6) by activating a main combustor (2) to gradually increase the temperature of an exhaust gas (G3) while with the use of the inverter motor (IM) the rotation speed is maintained at the partial rotation speed, and a speed increasing step of increasing the rotation speed to the rated rotation speed with the use of the inverter motor (IM) while the fuel burning amount of the main combustor (2) is increased.

### CROSS REFERENCE TO THE RELATED APPLICATION

This application is a continuation application, under 35 U.S.C §111(a) of international application No. PCT/JP2012/081814, filed Dec. 7, 2012, which claims priority to Japanese patent application No. 2011-280947, filed Dec. 22, 2011, the entire disclosure of which is herein incorporated by reference.

### BACKGROUND OF THE INVENTION

1. Field of the Invention

The present invention relates to a gas turbine engine of a type equipped with a heat exchanger for performing a heat exchange between an exhaust gas of a turbine and a compressed gas compressed by a compressor, and also to a method of starting such gas turbine engine.

2. Description of Related Art

For a high efficiency achieved by the gas turbine engine, in recent years the chances of employing a regenerative cycle utilizing a heat exchanger is increasing. The heat exchanger employed in the gas turbine engine is required to be robust enough to withstand a high temperature and a high pressure and to be highly efficient and space saving, and such a heat exchanger as, for example, a blade fine type or a tube type is generally utilized. In this respect, see, for example, the patent documents 1 and 2 listed below.

### PRIOR ART LITERATURE

Patent Document 1: Japanese Patent No. 5039366

Patent Document 1: Japanese Patent No. 5048389

In general, the start of the gas turbine takes place in a matter of minutes and the heat exchanger, which is a relatively large structure, is subjected to a large thermal shock when the temperature of exhaust gases emitted from the gas turbine abruptly increases at the time of start of the gas turbine. Specifically, at the time of start of the gas turbine engine, the gas turbine engine is rotated by a starter utilizing a compressed air and, at the same time, fuel is invested in to ignite. Immediately after the ignition of a combustor, the gas temperature at a heat exchanger inlet attains a peak value and the thermal stress within the heat exchanger is maximized. Since the peak of the thermal stress emerges at the start of the gas turbine engine, the ruggedness of the heat exchanger is deteriorated as the frequency of the turbine engine being started increases.

### SUMMARY OF THE INVENTION

The present invention has been devised to substantially eliminate the foregoing problems and inconveniences and is intended to provide a gas turbine engine of a type, in which an excessive thermal stress developed inside the heat exchanger at the time of start of such turbine engine, and a method of starting the gas turbine engine.

In order to accomplish the foregoing object, the present invention provides a method of starting a gas turbine engine including a compressor to compress an intake air to thereby generate a compressed gas, a combustor to burn the compressed gas to thereby generate a high temperature, high pressure combustion gas, a turbine driven by the combustion gas to thereby generate an exhaust gas, a starter device, and a heat exchanger for heating the compressed gas by means of the exhaust gas. The gas turbine engine starting method according to the present invention includes a primary warming step of warming up the heat exchanger by the compressed air while the rotation speed of the gas turbine engine is maintained at a partial rotation speed with the use of the starter device, a secondary warming step of warming up the heat exchanger by gradually increasing a temperature of the exhaust gas by the activation of the combustor while the partial rotation speed is maintained with the use of the starter device, and a speed increasing step of increasing the engine rotation speed to a rated rotation speed by increasing a fuel burning amount of the combustor, that is, the amount of fuel supplied to the combustor and also increasing the engine rotation speed with the use of the starter device.

According to the present invention, the warm-up of the heat exchanger is carried out in two stages of the primary warm-up with the use of the compressed gas and the secondary warm-up with the use of the exhaust gas to thereby gradually increase the temperature of the compressed gas at the inlet of the heat exchanger. Therefore, the excessive thermal shock to the heat exchanger, which is generated at the time of start of the turbine engine, can be suppressed markedly.

In a preferred embodiment of the present invention, the starter device preferably includes a rotating machine concurrently serving as a power generator that is driven by the turbine. According to this feature, by utilizing the inverter motor as the starter device, the conventional starter hitherto required separately is no longer needed and the structure is rendered to be simplified.

In a preferred embodiment of the present invention, the rotating machine is preferably connected with a power converter comprised of an inverter and a converter, the starter device including an inverter motor, in which case the rotating machine is driven as a starter device by the power converter; during the primary and secondary warming steps, the partial rotation speed is maintained by the inverter motor; and during the speed increasing step, the rotation speed of the gas turbine engine is increased by the inverter motor to boost to the rated rotation speed. According to this feature, the power converter can maintain the rotation speed at a constant value, while the compressed gas temperature at the inlet of the heat exchanger is increased. Accordingly, the rotation speed can be constantly maintained by the time the warming completes. Also, while in the past the control of the rotation speed has been carried out by adjusting the flow rate of the fuel, with the use of the power converter the control of the rotation speed is carried out by the inverter motor and the supply of the fuel can be exclusively relied on the drive of the rotating machine. As a result, the degree of freedom of design can be increased.

In another preferred embodiment of the present invention, the gas turbine engine may be used as a lean fuel intake gas turbine engine. Since the lean fuel intake gas turbine engine does not boot so frequently, influence brought about on the system as a whole is minimal even through the starting time is long. The lean fuel is a fuel containing a small amount of an flammable component such as, for example, a ventilation air methane and/or a coal mine methane both produced in coal mines that does not ignite upon compression by the compressor.

In a further preferred embodiment of the present invention, during the secondary warming step, the fuel burning amount in the combustor is preferably increased to thereby gradually increase the temperature of the exhaust gas. According to this feature, the two stage warm-ups can be accomplished with a simplified structure.

In a still further preferred embodiment of the present invention, the use may be made of an auxiliary combustor to boost the temperature of the exhaust gas at the time of start, so that during the secondary warming step the fuel burning amount of the auxiliary combustor is increased to thereby gradually increase the temperature of the exhaust gas. According to this feature, since the fuel burning amount of the auxiliary combustor is adjusted, there is no need to consider any change in combustion characteristic in a rated condition of the main combustor. Therefore, the fuel burning amount can be adjusted at the time of ignition of the auxiliary combustor and in a condition in which the fuel burning amount of the auxiliary combustor is small.

In a yet further preferred embodiment of the present invention, where the auxiliary combustor is used, by the auxiliary combustor, a fuel is preferably mixed with an extracted gas partially extracted from the compressed gas, to thereby provide a warming gas that has been flame burned, and then the warming gas is mixed in the exhaust gas, and during the secondary warming step the adjustment of the fuel burning amount of the auxiliary combustor is carried out by combining with a control of the flow rate of the fuel and the flow rate of the extracted gas. According to this feature, the fuel burning amount in the auxiliary combustor can be further meticulously adjusted.

The present invention in accordance with another aspect thereof provides a gas turbine engine which includes a compressor to compress an intake air to thereby generate a compressed gas; a combustor to burn the compressed gas to generate a high temperature, high pressure combustion gas; a turbine driven by the combustion gas to thereby generate an exhaust gas; a starter device; a heat exchanger to heat the compressed gas by means of the exhaust gas; an auxiliary combustor to boost a temperature of the exhaust gas at the time of starting; and a controller. In this gas turbine engine, the controller performs such a control that a primary warm-up for the heat exchanger by means of the compressed gas is carried out while the rotation speed is maintained at a partial rotation speed by the starter device, a secondary warm-up for the heat exchanger is carried out by activating the auxiliary combustor and gradually increasing the temperature of the exhaust gas while the partial rotation speed is maintained by the starter device, and further, the fuel burning amount of the combustor is increased while the rotation speed is increased, to thereby attain the rated rotation speed with the use of the starter device.

According to the other aspect of the present invention, the warm-up of the heat exchanger is carried out in two stages of the primary warm-up with the use of the compressed gas and the secondary warm-up with the use of the exhaust gas to thereby gradually increase the temperature of the compressed gas at the inlet of the heat exchanger. Therefore, the excessive thermal shock to the heat exchanger, which is generated at the time of start of the turbine engine, can be suppressed markedly. Also, since the fuel burning amount of the auxiliary combustor is adjusted, there is no need to consider any change in combustion characteristic in a rated condition of the main combustor. Therefore, the fuel burning amount can be adjusted at the time of ignition of the auxiliary combustor and in a condition in which the fuel burning amount of the auxiliary combustor is small.

In the gas turbine engine of the type referred to above, the starter device preferably includes a rotating machine which concurrently serves as an power generator that is driven by the turbine, with the rotating machine connected with a power converter comprised of an inverter and a converter; the starter device includes an inverter motor; the power converter drives the rotating machine as a starter device; and the inverter motor maintains the rotation speed at the partial rotation speed during the warm-up of the heat exchanger and, after completion of the secondary warm-up, the rotation speed is increased to the rated rotation speed.

According to the above structural feature, the power converter can maintain the rotation speed at a constant value, while the compressed gas temperature at the inlet of the heat exchanger is increased. Accordingly, the rotation speed can be constantly maintained by the time the warming completes. Also, while in the past the control of the rotation speed has been carried out by adjusting the flow rate of the fuel, with the use of the power converter the control of the rotation speed is carried out by the inverter motor and the supply of the fuel can be exclusively relied on the drive of the rotating machine. As a result, the degree of freedom of design can be increased. In addition, by utilizing the inverter motor as the starter device, the conventional starter hitherto required separately is no longer needed and the structure is rendered to be simplified.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of preferred embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic diagram showing a gas turbine engine equipped with a heat exchanger in accordance with a first preferred embodiment of the present invention;

FIG. 2 is a characteristic chart showing changes in fuel valve opening, heat exchanger inlet temperature and rotation speed exhibited at the time of start of the gas turbine engine according to the first embodiment of the present invention;

FIG. 3 is a schematic structural diagram showing the gas turbine engine in accordance with a second preferred embodiment of the present invention;

FIG. 4 is a characteristic chart showing changes in fuel valve opening, heat exchanger inlet temperature and rotation speed exhibited at the time of start of the gas turbine engine according to the second embodiment of the present invention; and

FIG. 5 is a schematic structural diagram showing the gas turbine engine in accordance with a third preferred embodiment of the present invention.

### DESCRIPTION OF PREFERRED EMBODIMENTS

Hereinafter, some preferred embodiments of the present invention will be described in detail with reference to the accompanying drawings.

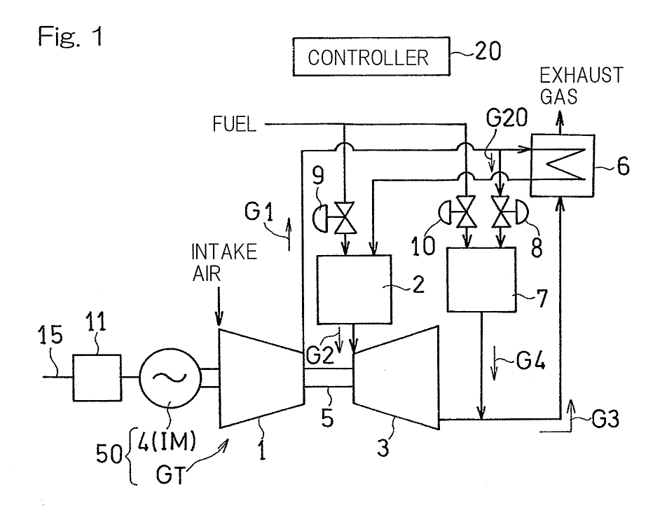

In particular, FIG. 1 illustrates a schematic structural diagram showing a gas turbine engine designed in accordance with a first preferred embodiment of the present invention. The gas turbine engine GT shown in FIG. 1 includes a compressor 1, a main combustor 2 comprised of a catalytic combustor containing a catalyst such as, for example, platinum and/or palladium, and a turbine 3. By an output of the gas turbine engine GT, a rotating machine 4 concurrently serving as a power generator and a starter device is driven. The rotating machine 4 is connected with a power converter 11 comprised of an inverter and a converter, and the starter device includes an inverter motor IM.

An intake air such as, for example, air is compressed by the compressor 1 to generate a high pressure compressed gas G1, and the compressed gas G1 is supplied to the main combustor 2. This compressed gas G1 so supplied to the main combustor 2 is burned as a result of a catalytic reaction of the catalyst such as, for example, platinum and/or palladium contained in the main combustor 2 to produce a high temperature, high pressure combustion gas G2 which is in turn supplied to the turbine 3 to drive the latter. The turbine 3 is drivingly connected with the compressor 1 through a rotary shaft 5, and the compressor 1 is driven by the turbine 3. In this way, an electric power generating device 50 is formed in combination with the gas turbine engine GT and the rotating machine 4.

The gas turbine engine GT also includes a heat exchanger 6 for heating the compressed gas G1, which is introduced from the compressor 1 into the main combustor 2, by means of the exhaust gas G3 fed from the turbine 3, and an auxiliary combustor 7 in the form of a warming burner for boosting the temperature of the exhaust gas G3 at the time of start of the gas turbine engine GT to thereby increase the temperature of the compressed gas G1 flowing into the main combustor 2 so that the catalyst can be activated. This auxiliary combustor 7 serves to mix fuel into an extracted gas G20 partially extracted from the compressed gas G1 to thereby generate a warming gas G4, which has been burned by flames, and then mix the extracted gas G20 into the exhaust gas G3, supplied from the turbine 2 to the heat exchanger 6. The auxiliary combustor 7 is fluid connected with a bleed valve 8 for controlling the flow rate of the extracted gas G20 then flowing towards the auxiliary combustor 7. The exhaust gas G3 emerging from the heat exchanger 6 is, after having been silenced by a silencer (not shown), discharged to the outside. The control of the flow rate of the extracted gas G20 by the bleed valve 8 is carried out in response to an output signal from a controller 20.

The supply of fuel to the auxiliary combustor 7 takes place while the flow rate thereof is adjusted by a second fuel control valve 10. The supply of fuel to the main combustor 2 takes place while the flow rate thereof is adjusted by a first fuel control valve 9. The respective flow rate adjustments performed by the first and second fuel control valves 9 and 10 are also accomplished by the controller 20.

The rotary shaft 5 connecting the compressor 1 and the turbine 3 together is in the form of a single shaft, and this rotary shaft 5 and the rotating machine 4 are connected together. The electric power obtained from the rotary machine 4 that is driven by the rotation of the turbine 3 is inputted to the controller 20.

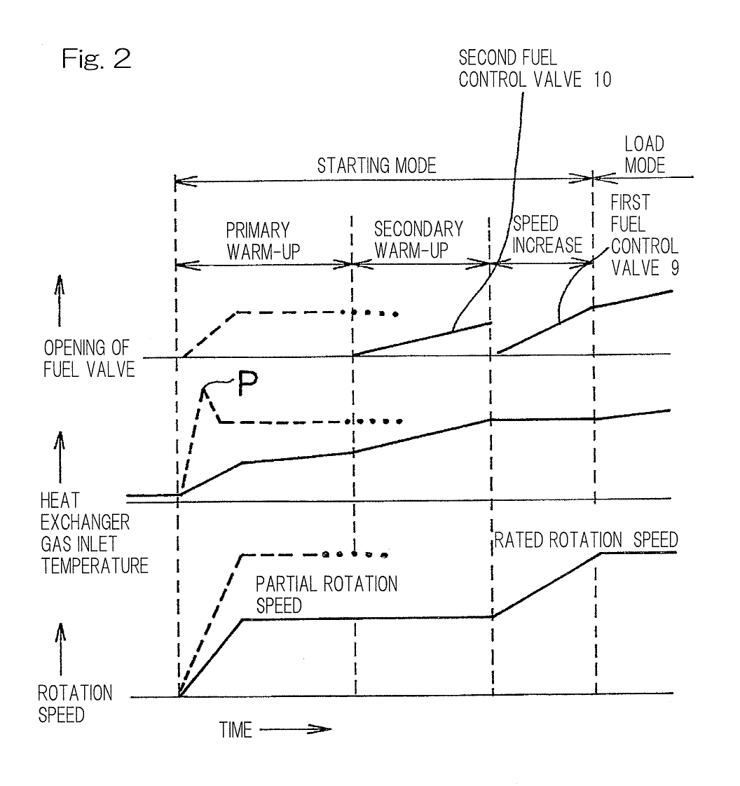

The operation of the gas turbine engine GT of the structure described above will now be described. Controls of the equipments are all carried out by the controller 20. At the time of start, without being ignited, in response to a command from the controller 20 the power converter 11 drives the rotating machine 4 as a starter device (i.e., the start of a starting mode). At this time, the inverter motor IM maintains a constant partial rotation speed or partial number of revolutions (i.e., the primary warm-up). The rotation speed maintained is, for example, the rotation speed departing from a point of resonance of a shaft vibration or a blade vibration. It is to be noted that in FIG. 2, the solid lines represent characteristics of the gas turbine engine designed in accordance with this embodiment and the broken lines represent characteristics of the conventional gas turbine engine.

During this primary warm-up, by the action of the compressed gas G1 which has been compressed and then boosted by the compressor 1 shown in FIG. 1, the heat exchanger 6 is warmed up without the heat exchanger gas inlet temperature being changed markedly as shown in FIG. 2. The heat exchanger gas inlet temperature is equal to the temperature of the exhaust gas G3 flowing within an exhaust duct which fluid connects between the turbine 3 and the heat exchanger 6.

Thereafter, while the constant partial rotation speed referred to previously is maintained by the power converter 11, the bleed valve 8 and the second fuel control valve 10 are opened to ignite the auxiliary combustor 7. As shown in FIG. 2, the opening of the second fuel control valve 10 is gradually increased to gradually increase the fuel burning amount, that is, the amount of fuel supplied and, by so doing, the heat exchanger 6 shown in FIG. 1 is warmed up without considerably changing the heat exchanger gas inlet temperature (i.e., the secondary warm-up). In the illustrated embodiment, the length of time during which each of the primary and secondary warm-ups takes place is set by a timing device such as, for example, a timer, but the use of thermometers may be made at outlet and inlet ports of the heat exchanger 6, respectively, so that the length of each of the primary and secondary warm-ups may be adjusted on the basis of a measured value of those thermometers.

After the termination of the warm-up of the heat exchanger 6, the bleed valve 8 and the second fuel control valve 10 are closed to allow the auxiliary combustor 7 to be extinguished. On the other hand, the first fuel control valve 9 is opened and the main combustor 2 is ignited. Then, as shown in FIG. 2, the fuel burning amount at the main combustor 2 is increased by gradually opening the first fuel control valve 9 and, at the same time, the rotation speed of the gas turbine engine is increased to the rated rotation speed without considerably changing the heat exchanger gas inlet temperature (i.e., the speed increasing step). The idling run terminates at the timing the secondary warm-up completes, and, thereafter, at the timing the rated rotation speed is attained, a starting mode is switched over to a load mode, that is, an electric power generating mode. In other words, during the starting mode, the gas turbine engine GT is driven by a commercial electric power.

Although in the foregoing description, the adjustment of the fuel burning amount of the auxiliary combustor 7 during the second warm-up, that is, the adjustment of the amount of supply of the fuel to the auxiliary combustor 7 has been carried out by the second fuel control valve 10, the control of the flow rate of the air by the bleed valve 8 can be combined therewith. By so doing, a further meticulous adjustment can be accomplished. Also, where the gas turbine engine is booted while the heat exchanger has been warmed up such as occurring when the gas turbine engine is rebooted immediately after the halt, the startup mode may not be accompanied by the primary warm-up and may be started with the secondary warm-up. By so doing, the length of booting time can be shortened.

In the construction described above, as shown by the broken lines in FIG. 2, with the conventional gas turbine engine, the fuel valve is opened at the low rotation speed during the startup to ignite the combustor so allow the rated rotation speed to be attained in a short length of time. Because of that, the heat exchanger gas inlet temperature attains the peak P immediately after the beginning of the startup and the thermal shock to the heat exchanger 6 tends to be excessive. In contrast thereto, according to the foregoing embodiment, the heat exchanger 6 shown in FIG. 1 is warmed in two stages comprised of the primary warm-up by the compressed gas G1 and the secondary warm-up by the exhaust gas G3 of the auxiliary combustor 7, and by so doing, the heat exchanger gas inlet temperature shown in FIG. 2 is gradually increased. Accordingly, the excessive thermal stress on the heat exchanger 6, which occurs during the startup, can be markedly suppressed.

Also, since the use is made of the power converter 11 shown in FIG. 1, the rotation speed can be maintained at a constant value while the heat exchanger gas inlet temperature is gradually increased, as shown in FIG. 2. Accordingly, the rotation speed by the time the warm-up is completed can be maintained at a constant value.

During the secondary warm-up the second fuel control valve 10 is controlled, that is, the fuel burning amount of the auxiliary combustor 7 shown in FIG. 1 is adjusted. Accordingly, there is no need to consider a change in combustion characteristic at a rated condition of the main combustor 2 and, therefore, the fuel burning amount, at the time when the auxiliary combustor 7 is fired and the fuel burning amount is small, can be adjusted.

Also, while in the conventional gas turbine engine the control of the rotation speed has been carried out by adjusting the flow rate of the fuel, in the foregoing embodiment the control of the rotation speed is carried out with the inverter motor IM using the power converter 11 and the supply of the fuel can be exclusively relied on the electric power generation. As a result, the freedom of design can be increased. In addition, with the inverter motor IM used as the starter device, the use of the conventional starter hitherto required separately can be dispensed with and the structure can therefore be simplified.

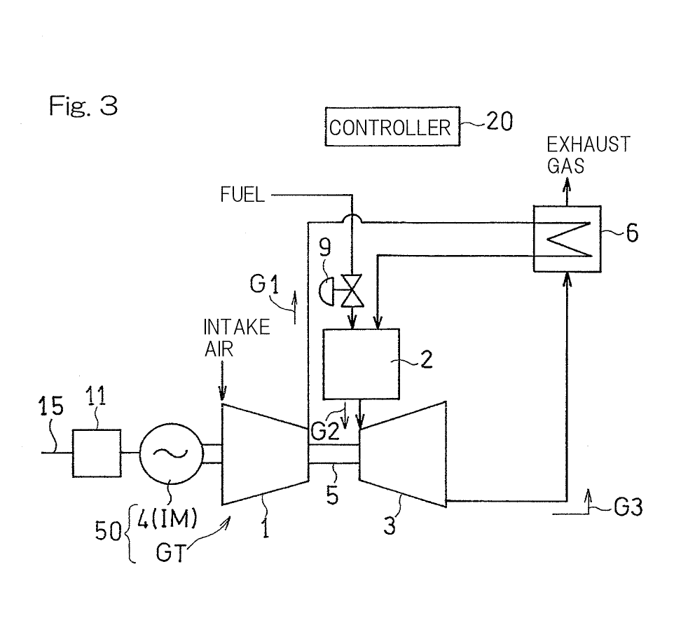

FIG. 3 illustrates a schematic structural diagram of the gas turbine engine designed in accordance with a second preferred embodiment of the present invention. This second embodiment is substantially similar to the previously described first embodiment shown in FIG. 1, but differs therefrom in that the auxiliary combustor 7 and the bleed valve 8 and the second fuel control valve 10 are dispensed with in the second embodiment, noting that other structural features than that described above are similar to those in the previously described first embodiment.

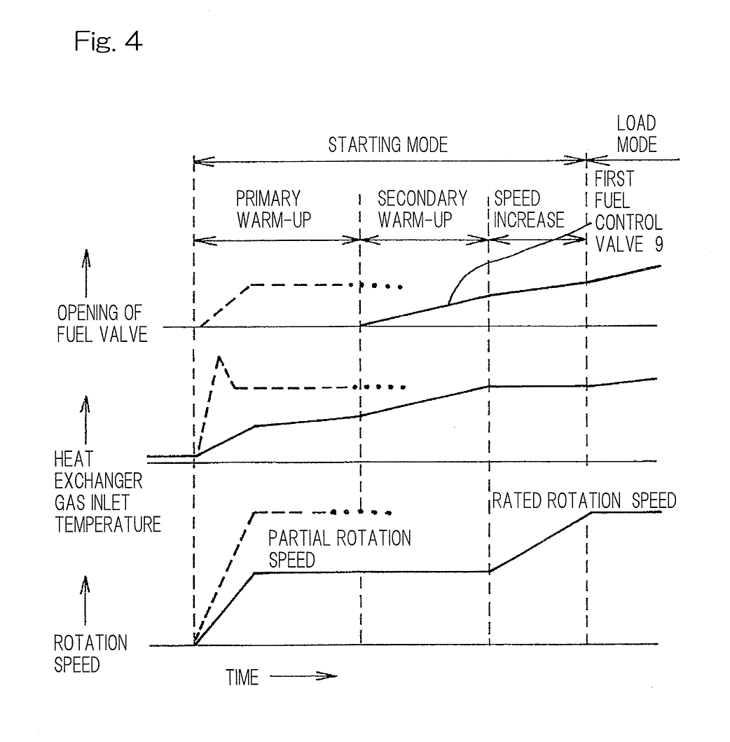

FIG. 4 illustrates characteristics of the gas turbine engine GT according to the second embodiment. As shown in FIGS. 3 and 4, in the practice of the second embodiment, after the termination of the primary warm-up, while a revolving number constant control is carried out by means of the power converter 11, the first fuel control valve is opened to ignite the main combustor 2. Therefore, the opening of the first fuel control valve 9 is gradually increased to moderately increase the fuel burning amount of the main combustor 2 so that the warm-up of the heat exchanger 6 (the second warm-up) may complete without considerably changing the heat exchanger gas inlet temperature.

After the completion of the secondary warm-up, the opening of the first fuel control valve 9 is further increased to increase the fuel burning amount in the main combustor 2 so that the rotation speed of the gas turbine engine is increased to the rated rotation speed without the heat exchanger gas inlet temperature being changed considerably. After the attainment to the rated rotation speed, the load mode is transferred.

Even in this second embodiment, the heat exchanger 6 shown in FIG. 3 is warmed up in two stages comprised of the primary warm-up by means of the compressed gas G1 and the secondary warm-up by means of the exhaust gas G3 of the main combustor 2, to thereby gradually increase the heat exchanger gas inlet temperature as shown in FIG. 4. Accordingly, it is possible to markedly suppress the excessive thermal stress from developing in the heat exchanger 6 which would otherwise occur during the startup time, and therefore, the generation of cracking in the heat exchanger can be avoided.

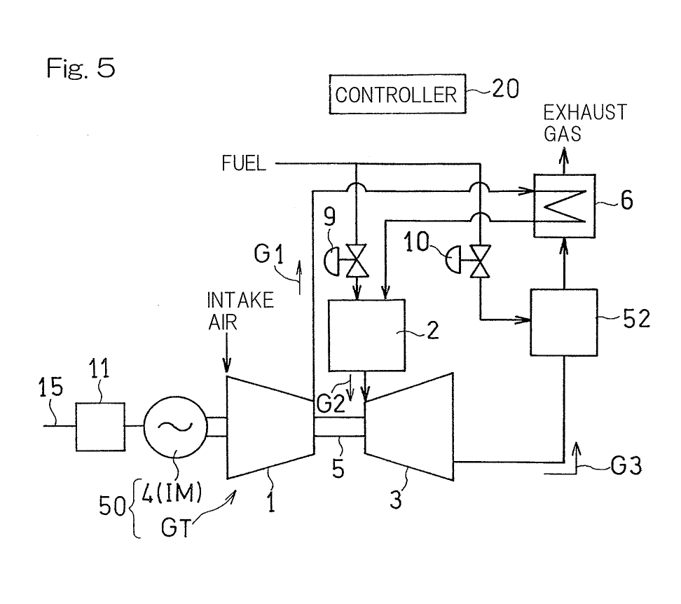

FIG. 5 illustrates a schematic structural diagram of the gas turbine engine designed in accordance with a third preferred embodiment of the present invention. This third embodiment is substantially similar to the previously described first embodiment shown in FIG. 1, but differs therefrom in that a duct burner 52 disposed in an exhaust duct connecting between the turbine 3 and the heat exchanger 6 is employed in this third embodiment, noting that other structural features than that described above are similar to those in the previously described first embodiment. Accordingly, even in this third embodiment, effects similar to those afforded by the previously described first embodiment shown in FIG. 1 can be obtained.

Although in describing the foregoing embodiment, the catalytic combustor has been shown and described as the main combustor 2, the main combustor 2 need not necessarily be limited thereto. Also, the present invention can be equally applied to a lean fuel intake gas turbine engine of a type in which a low calorie gas is used as a fuel. Such low calorie gas may be a mixture of a coal mine methane (CMM) produced in coal mines with, for example, air and/or a ventilation air methane (VAM) exhausted from coal mines and may be used as a working gas having a concentration lower than the flammable limit concentration so that the mixture will not be ignited as a result of compression taking place in the compressor, which mixture is supplied into the engine to enable a combustible component contained therein. In particular, the present invention is effective to a system such as, for example, the lean fuel intake gas turbine engine which is not frequently boosted.

Although the present invention has been fully described in connection with the preferred embodiments thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

### REFERENCE NUMERALS

1 . . . Compressor

2 . . . Main combustor (Combustor)

3 . . . Turbine

4 . . . Rotating machine (Starter device)

6 . . . Heat exchanger

7 . . . Auxiliary combustor

11 . . . Power converter

20 . . . Controller

52 . . . Duct burner (Auxiliary combustor)

GT . . . Gas turbine engine

G1 . . . Compressed gas

G2 . . . Combustion gas

G3 . . . Exhaust gas

G20 . . . Extracted gas

IM . . . Starter device (Inverter motor)

What is claimed is:

1. A method of starting a gas turbine engine including a compressor to compress an intake air to thereby generate a compressed gas, a combustor to burn the compressed gas to thereby generate a high temperature, high pressure combustion gas, a turbine driven by the combustion gas to thereby an exhaust gas, a starter device, and a heat exchanger to heat the compressed gas by means of the exhaust gas, the gas turbine engine starting method comprising:
a primary warming step of warming up the heat exchanger by the compressed air while the rotation speed of the gas turbine engine is maintained at a partial rotation speed with the use of the starter device;
a secondary warming step of warming up the heat exchanger by gradually increasing a temperature of the exhaust gas by the activation of the combustor while the partial rotation speed is maintained with the use of the starter device, and
a speed increasing step of increasing the engine rotation speed to a rated rotation speed by increasing a fuel burning amount of the combustor and also increasing the engine rotation speed with the use of the starter device.

2. The gas turbine engine starting method as claimed in claim 1, wherein the starter device comprises a rotating machine concurrently serving as a power generator that is driven by the turbine.

3. The gas turbine engine starting method as claimed in claim 2, wherein the rotating machine is connected with a power converter comprised of an inverter and a converter, the starter device including an inverter motor;
the rotating machine is driven as a starter device by the power converter;
during the primary and secondary warming steps, the partial rotation speed is maintained by the inverter motor; and
during the speed increasing step, the rotation speed of the gas turbine engine is increased by the inverter motor to boost to the rated rotation speed.

4. The gas turbine engine starting method as claimed in claim 1, wherein the gas turbine engine is used as a lean fuel intake gas turbine engine.

5. The gas turbine engine starting method as claimed in claim 1, wherein during the secondary warming step, the fuel burning amount in the combustor is increased to thereby gradually increase the temperature of the exhaust gas.

6. The gas turbine engine starting method as claimed in claim 1, wherein an auxiliary combustor to boost the temperature of the exhaust gas at the time of start is provided; and
during the secondary warming step the fuel burning amount of the auxiliary combustor is increased to thereby gradually increase the temperature of the exhaust gas.

7. The gas turbine engine starting method as claimed in claim 6, wherein by the auxiliary combustor, a fuel is mixed with an extracted gas partially extracted from the compressed gas, to provide a warming gas that has been flame burned, and then the warming gas is mixed in the exhaust gas and warmed, and
during the secondary warming step the adjustment of the fuel burning amount of the auxiliary combustor is carried out by combining with a control of the flow rate of the fuel and the flow rate of the extracted gas.

8. A gas turbine engine which comprises:
a compressor to compress an intake air to thereby generate a compressed gas;
a combustor to burn the compressed gas to thereby generate a high temperature, high pressure combustion gas;
a turbine driven by the combustion gas to thereby generate an exhaust gas;
a starter device;
a heat exchanger to heat the compressed gas by means of the exhaust gas;
an auxiliary combustor to boost a temperature of the exhaust gas at the time of starting; and
a controller which performs such a control that a primary warm-up for the heat exchanger by means of the compressed gas is carried out while the rotation speed is maintained at a partial rotation speed by the starter device, a secondary warm-up for the heat exchanger is carried out by activating the auxiliary combustor and gradually increasing the temperature of the exhaust gas while the partial rotation speed is maintained by the starter device, and further, the fuel burning amount of the combustor is increased while the rotation speed is increased, to thereby attain the rated rotation speed with the use of the starter device.

9. The gas turbine engine as claimed in claim 8, wherein the starter device comprises a rotating machine which concurrently serves as an power generator that is driven by the turbine;
the rotating machine is connected with a power converter comprised of an inverter and a converter;
the starter device includes an inverter motor;
the power converter drives the rotating machine as a starter device; and
the inverter motor maintains the rotation speed at the partial rotation speed during the warm-up of the heat exchanger and, after completion of the secondary warm-up, the rotation speed is increased to the rated rotation speed.
